(19) United States
(12) Patent Application Publication
(10) Pub. No.: US 2014/0312620 A1
(43) Pub. Date: Oct. 23, 2014

(54) METHOD AND APPARATUS FOR IMPROVING GRID STABILITY IN A WIND FARM

(71) Applicant: GENERAL ELECTRIC COMPANY, Schenectady, NY (US)

(72) Inventors: Arne Korber, Berlin (DE); Sid Ahmed Attia, Berlin (DE)

(73) Assignee: General Electric Company, Schenectady, NY (US)

(21) Appl. No.: 13/864,345

(22) Filed: Apr. 17, 2013

(51) Int. Cl. F03D 7/02

(52) U.S. Cl. CPC F03D 7/0284
USPC 290/44

(57) ABSTRACT

A method for operating a wind farm having at least two wind turbines includes measuring wind velocity at a selectable distance in front of at least one wind turbine of the wind farm in an upwind direction of the wind turbine, generating a signal from said measured wind velocity, estimating the wind velocity at the location of the wind turbine based on the generated signal, measuring at least one grid parameter of the utility grid, and controlling power output of the wind turbine in response to the estimated wind velocity and the measured grid parameter.

### BACKGROUND OF THE INVENTION

The subject matter described herein relates generally to methods and systems for wind energy production, and more particularly, to a method for improving grid stability in a wind farm. Furthermore, embodiments of the present application relate to an apparatus for grid stability improvements.

Generally, a wind turbine includes a rotor that includes a rotatable hub assembly having multiple blades. The blades transform wind energy into a mechanical rotational torque that drives one or more generators via the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbines also exist. The rotor, generator, gearbox and other components are typically mounted within a housing, or nacelle, that is positioned on top of a base that may be a truss or tubular tower.

Some wind turbine configurations include double-fed induction generators (DFIGs). Such configurations may also include power converters that are used to convert a frequency of generated electric power to a frequency substantially similar to a utility grid frequency. Moreover, such converters, in conjunction with the DFIG, also transmit electric power between the utility grid and the generator as well as transmit generator excitation power to a wound generator rotor from one of the connections to the electric utility grid connection. Alternatively, some wind turbine configurations include, but are not limited to, alternative types of induction generators, permanent magnet (PM) synchronous generators and electrically-excited synchronous generators and switched reluctance generators. These alternative configurations may also include power converters that are used to convert the frequencies as described above and transmit electrical power between the utility grid and the generator.

Known wind turbines have a plurality of mechanical and electrical components. Each electrical and/or mechanical component may have independent or different operating limitations, such as current, voltage, power, and/or temperature limits, than other components. Moreover, known wind turbines typically are designed and/or assembled with predefined rated power limits. To operate within such rated power limits, the electrical and/or mechanical components may be operated with large margins for the operating limitations. Such operation may result in inefficient wind turbine operation, and a capability of the wind turbine may be underutilized.

For operation and energy delivery, a wind turbine or a number of wind turbines of a wind farm, respectively, are connected to an electrical utility grid. Voltage variations occurring within this grid may have an influence on electrical components installed at the wind turbines and may be the reason for other problems within the wind farm. Thus, grid stabilization procedures are of increasing importance, the procedures being able to compensate, at least partially, for destabilizing events. It is thus desirable to provide grid stability and at the same time maintain satisfactory energy yield during wind energy conversion.

### BRIEF DESCRIPTION OF THE INVENTION

In one aspect, a method for controlling power generation of at least one wind turbine connected to a utility grid is provided, the method including measuring wind velocity at a selectable upwind distance of the wind turbine, generating a signal from said measured wind velocity, estimating the wind velocity at the location of the wind turbine based on the generated signal, measuring at least one grid parameter of the utility grid, and controlling power output of the wind turbine in response to the estimated wind velocity and the measured grid parameter.

In another aspect, a method for operating a wind farm including at least two wind turbines connected to a utility grid is provided, the method including measuring wind velocity at a selectable upwind distance of at least one wind turbine of the wind farm in an upwind direction of the wind turbine, generating a signal from said measured wind velocity, estimating the wind velocity at the location of at least one of the wind turbines based on the generated signal, measuring at least one grid parameter of the utility grid, and controlling power generation of the wind farm based on the estimated wind velocity and the measured grid parameter such that the utility grid is stabilized.

In yet another aspect, a utility grid stabilizing system adapted for controlling stability of a grid connected to a wind turbine is provided, the grid stabilizing system including a wind turbine controller adapted for controlling the wind turbine, a wind velocity measurement device operatively connected to the wind turbine controller and being adapted for measuring wind velocity at a selectable upwind distance of the wind turbine, a grid operator operatively connected to the wind turbine controller and being adapted for determining actual grid parameters of the utility grid, wherein the controller is configured to control operation of the wind turbine based on the measured wind velocity and the actual grid parameters.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of a portion of an exemplary wind turbine.

FIG. 2 is a schematic view of an exemplary electrical and control system suitable for use with the wind turbine shown in FIG. 1.

FIG. 3 is a block diagram of a control signal generation unit connected to a wind turbine controller adapted for measuring upwind velocity and for estimating energy excess;

FIG. 4 is a block diagram for illustrating a wind farm control system including a wind farm operator and a utility grid operator;

FIG. 5 is a flowchart illustrating a method for controlling power generation of at least one wind turbine;

FIG. 6 is a flowchart illustrating a further method for operating a wind farm including at least two wind turbines; and

FIG. 7 is a block diagram illustrating a wind farm including wind turbines connected to a utility grid.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a utility grid stabilizing system, which is adapted for controlling the stability of a utility grid connected to a wind farm. The utility grid stabilizing system may include a wind farm operator for controlling at least one wind turbine included in the wind farm and a wind velocity measurement device operatively connected to the wind farm operator and adapted for measuring an upwind velocity at a selectable distance in front of the wind turbine, or in front of the rotor of the wind turbine, respectively. A grid operator may be connected to the wind farm operator and is adapted for determining actual grid parameters of the utility grid. The at least one wind turbine of the wind farm may then be controlled based on the measured wind velocity and actual grid parameters.

According to further embodiment which may be combined with other embodiments described herein, the wind velocity, e.g. an upwind velocity (upfront velocity) is measured such that a wind velocity measurement signal may be obtained from the wind velocity measurement device. Then, spatial and/or temporal filtering of the wind velocity measurement signal may be provided. The wind velocity at the location of the wind turbine may be estimated based on the filtered measurement signal. Then, the wind turbine may be operated in response to the estimated wind velocity.

In a similar manner, the method can be used for controlling entire wind farms. The method according to another typical embodiment may include measuring wind velocity at a selectable distance in front of at least one wind turbine of the wind farm in an upwind direction of the turbine by means of at least one wind velocity measurement device arranged at the respective wind turbine, and by obtaining at least one wind velocity measurement signal from the wind velocity measurement device. A spatial and/or temporal filtering of the wind velocity measurement signal may be provided such that the wind velocity at the location of the wind turbine may be estimated based on the filtered measurement signal. The power generation of the entire wind farm may then be controller based on the estimated wind velocity.

A further technical effect is the knowledge of a wind resource such that grid destabilizing events may be compensated, at least partially. In addition to that, or alternatively, power excess estimation may be based on the determination of the estimated wind velocity.

As used herein, the term “LIDAR” (light detection and ranging) is intended to be representative of a procedure and/or a system adapted for measuring properties of ambient air by means of at least one (laser) light beam and the respective detection optics. Properties of ambient air may include, but are not limited to, wind velocity, upwind velocity, wind direction, turbulence, air composition, etc. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

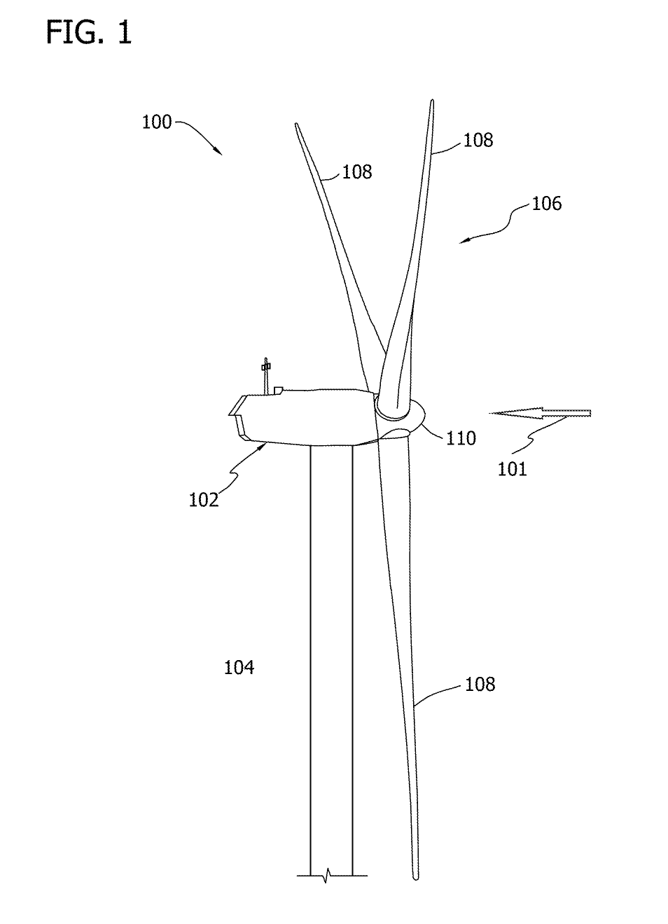

FIG. 1 is a perspective view of a portion of an exemplary wind turbine 100. Wind turbine 100 includes a nacelle 102 housing a generator (not shown in FIG. 1). Nacelle 102 is mounted on a tower 104 (a portion of tower 104 being shown in FIG. 1). Tower 104 may have any suitable height that facilitates operation of wind turbine 100 as described herein. Wind velocity having a direction 101 may be measured at a selectable upwind distance in front of the wind turbine. It is noted here that direction 101 may be the wind direction at the location of a specific wind turbine 100, or direction 101 may represent an averaged direction of a number of wind velocity directions present at a number of individual wind turbines 100. Wind turbine 100 also includes a rotor 106 that includes three blades 108 attached to a rotating hub 110. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

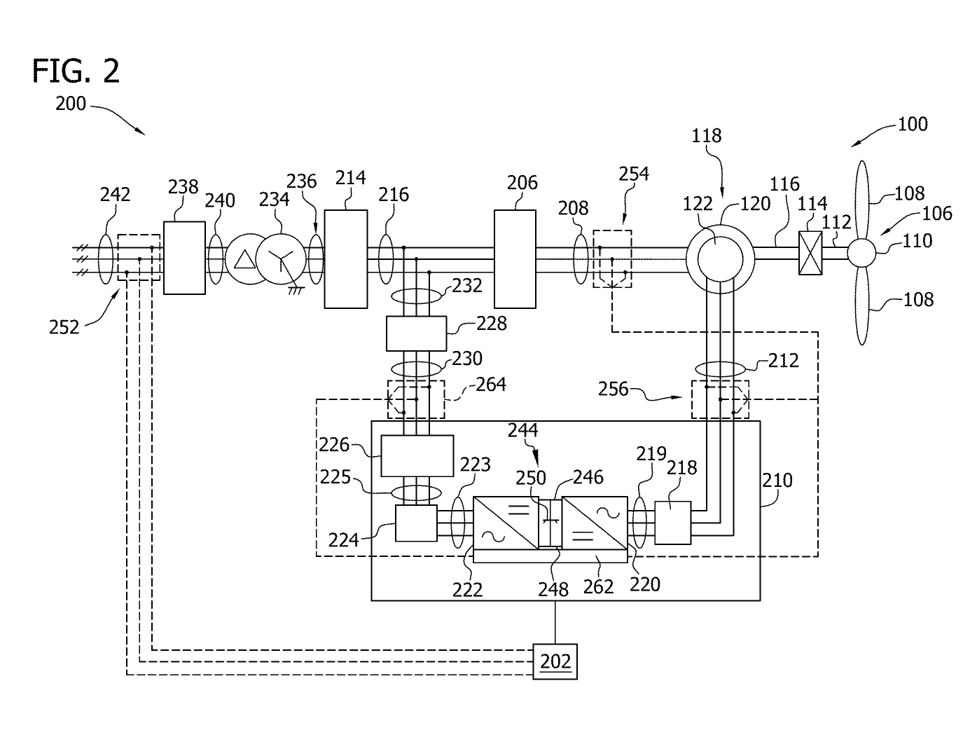

FIG. 2 is a schematic view of an exemplary electrical and control system 200 that may be used with wind turbine 100. Rotor 106 includes blades 108 coupled to hub 110. Rotor 106 also includes a low-speed shaft 112 rotatably coupled to hub 110. Low-speed shaft 112 is coupled to a step-up gearbox 114 that is configured to step up the rotational speed of low-speed shaft 112 and transfer that speed to a high-speed shaft 116. In the exemplary embodiment, gearbox 114 has a step-up ratio of approximately 0:1. For example, low-speed shaft 112 rotating at approximately 20 revolutions per minute (rpm) coupled to gearbox 114 with an approximately 0:1 step-up ratio generates a speed for high-speed shaft 116 of approximately 1400 rpm. Alternatively, gearbox 114 has any suitable step-up ratio that facilitates operation of wind turbine 100 as described herein. As a further alternative, wind turbine 100 includes a direct-drive generator that is rotatably coupled to rotor 106 without any intervening gearbox.

High-speed shaft 116 is rotatably coupled to generator 118. In the exemplary embodiment, generator 118 is a wound rotor, three-phase, double-fed induction (asynchronous) generator (DFIG) that includes a generator stator 120 magnetically coupled to a generator rotor 122. In an alternative embodiment, generator rotor 122 includes a plurality of permanent magnets in place of rotor windings. Moreover, generator 118 may be provided as an electrically excited synchronous motor.

Electrical and control system 200 includes a turbine controller 202. Turbine controller 202 includes at least one processor and a memory, at least one processor input channel, at least one processor output channel, and may include at least one computer (none shown in FIG. 2). As used herein, the term computer is not limited to integrated circuits referred to in the art as a computer, but broadly refers to a processor, a microcontroller, a microcomputer, a programmable logic controller (PLC), an application specific integrated circuit, and other programmable circuits (none shown in FIG. 2), and these terms are used interchangeably herein. In the exemplary embodiment, memory may include, but is not limited to, a computer-readable medium, such as a random access memory (RAM) (none shown in FIG. 2). Alternatively, one or more storage devices, such as a floppy disk, a compact disc read only memory (CD-ROM), a magneto-optical disk (MOD), and/or a digital versatile disc (DVD) (none shown in FIG. 2) may also be used. Also, in the exemplary embodiment, additional input channels (not shown in FIG. 2) may be, but are not limited to, computer peripherals associated with an operator interface such as a mouse and a keyboard (neither shown in FIG. 2). Further, in the exemplary embodiment, additional output channels may include, but are not limited to, an operator interface monitor (not shown in FIG. 2).

Processors for turbine controller 202 process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

Generator stator 120 is electrically coupled to a stator synchronizing switch 206 via a stator bus 208. In an exemplary embodiment, to facilitate the DFIG configuration, generator rotor 122 is electrically coupled to a bi-directional power conversion assembly 210 via a rotor bus 212. Alternatively, generator rotor 122 is electrically coupled to rotor bus 212 via any other device that facilitates operation of electrical and control system 200 as described herein. As a further alternative, electrical and control system 200 is configured as a full power conversion system (not shown) that includes a full power conversion assembly (not shown in FIG. 2) similar in design and operation to power conversion assembly 210 and electrically coupled to generator stator 120. The full power conversion assembly facilitates channeling electric power between generator stator 120 and an electric power transmission and distribution grid (not shown). In the exemplary embodiment, stator bus 208 transmits three-phase power from generator stator 120 to stator synchronizing switch 206. Rotor bus 212 transmits three-phase power from generator rotor 122 to power conversion assembly 210. In the exemplary embodiment, stator synchronizing switch 206 is electrically coupled to a main transformer circuit breaker 214 via a system bus 216. In an alternative embodiment, one or more fuses (not shown) are used instead of main transformer circuit breaker 214. In another embodiment, neither fuses nor main transformer circuit breaker 214 is used.

Power conversion assembly 210 includes a rotor filter 218 that is electrically coupled to generator rotor 122 via rotor bus 212. A rotor filter bus 219 electrically couples rotor filter 218 to a rotor-side power converter 220, and rotor-side power converter 220 is electrically coupled to a line-side power converter 222. Rotor-side power converter 220 and line-side power converter 222 are power converter bridges including power semiconductors (not shown). In the exemplary embodiment, rotor-side power converter 220 and line-side power converter 222 are configured in a three-phase, pulse width modulation (PWM) configuration including insulated gate bipolar transistor (IGBT) switching devices (not shown in FIG. 2) that operate as known in the art. Alternatively, rotor-side power converter 220 and line-side power converter 222 have any configuration using any switching devices that facilitate operation of electrical and control system 200 as described herein. Power conversion assembly 210 is coupled in electronic data communication with turbine controller 202 to control the operation of rotor-side power converter 220 and line-side power converter 222.

In the exemplary embodiment, a line-side power converter bus 223 electrically couples line-side power converter 222 to a line filter 224. Also, a line bus 225 electrically couples line filter 224 to a line contactor 226. Moreover, line contactor 226 is electrically coupled to a conversion circuit breaker 228 via a conversion circuit breaker bus 230. In addition, conversion circuit breaker 228 is electrically coupled to main transformer circuit breaker 214 via system bus 216 and a connection bus 232. Alternatively, line filter 224 is electrically coupled to system bus 216 directly via connection bus 232 and includes any suitable protection scheme (not shown) configured to account for removal of line contactor 226 and conversion circuit breaker 228 from electrical and control system 200. Main transformer circuit breaker 214 is electrically coupled to an electric power main transformer 234 via a generator-side bus 236. Main transformer 234 is electrically coupled to a grid circuit breaker 238 via a breaker-side bus 240. Grid circuit breaker 238 is connected to the electric power transmission and distribution grid via a grid bus 242. In an alternative embodiment, main transformer 234 is electrically coupled to one or more fuses (not shown), rather than to grid circuit breaker 238, via breaker-side bus 240. In another embodiment, neither fuses nor grid circuit breaker 238 is used, but rather main transformer 234 is coupled to the electric power transmission and distribution grid via breaker-side bus 240 and grid bus 242.

In the exemplary embodiment, rotor-side power converter 220 is coupled in electrical communication with line-side power converter 222 via a single direct current (DC) link 244. Alternatively, rotor-side power converter 220 and line-side power converter 222 are electrically coupled via individual and separate DC links (not shown in FIG. 2). DC link 244 includes a positive rail 246, a negative rail 248, and at least one capacitor 250 coupled between positive rail 246 and negative rail 248. Alternatively, capacitor 250 includes one or more capacitors configured in series and/or in parallel between positive rail 246 and negative rail 248.

Turbine controller 202 is configured to receive a plurality of voltage and electric current measurement signals from a first set of voltage and electric current sensors 252. Moreover, turbine controller 202 is configured to monitor and control at least some of the operational variables associated with wind turbine 100. In the exemplary embodiment, each of three voltage and electric current sensors 252 are electrically coupled to each one of the three phases of grid bus 242. Alternatively, voltage and electric current sensors 252 are electrically coupled to system bus 216. As a further alternative, voltage and electric current sensors 252 are electrically coupled to any portion of electrical and control system 200 that facilitates operation of electrical and control system 200 as described herein. As a still further alternative, turbine controller 202 is configured to receive any number of voltage and electric current measurement signals from any number of voltage and electric current sensors 252 including, but not limited to, one voltage and electric current measurement signal from one transducer.

As shown in FIG. 2, electrical and control system 200 also includes a converter controller 262 that is configured to receive a plurality of voltage and electric current measurement signals. For example, in one embodiment, converter controller 262 receives voltage and electric current measurement signals from a second set of voltage and electric current sensors 254 coupled in electronic data communication with stator bus 208. Converter controller 262 receives a third set of voltage and electric current measurement signals from a third set of voltage and electric current sensors 256 coupled in electronic data communication with rotor bus 212. Converter controller 262 also receives a fourth set of voltage and electric current measurement signals from a fourth set of voltage and electric current sensors 264 coupled in electronic data communication with conversion circuit breaker bus 230. Second set of voltage and electric current sensors 254 is substantially similar to first set of voltage and electric current sensors 252, and fourth set of voltage and electric current sensors 264 is substantially similar to third set of voltage and electric current sensors 256. Converter controller 262 is substantially similar to turbine controller 202 and is coupled in electronic data communication with turbine controller 202. Moreover, in the exemplary embodiment, converter controller 262 is physically integrated within power conversion assembly 210. Alternatively, converter controller 262 has any configuration that facilitates operation of electrical and control system 200 as described herein.

During operation, wind impacts blades 108 and blades 108 transform wind energy into a mechanical rotational torque that rotatably drives low-speed shaft 112 via hub 110. Low-speed shaft 112 drives gearbox 114 that subsequently steps up the low rotational speed of low-speed shaft 112 to drive high-speed shaft 116 at an increased rotational speed. High speed shaft 116 rotatably drives generator rotor 122. A rotating magnetic field is induced by generator rotor 122 and a voltage is induced within generator stator 120 that is magnetically coupled to generator rotor 122. Generator 118 converts the rotational mechanical energy to a sinusoidal, three-phase alternating current (AC) electrical energy signal in generator stator 120. The associated electrical power is transmitted to main transformer 234 via stator bus 208, stator synchronizing switch 206, system bus 216, main transformer circuit breaker 214 and generator-side bus 236. Main transformer 234 steps up the voltage amplitude of the electrical power and the transformed electrical power is further transmitted to a grid via breaker-side bus 240, grid circuit breaker 238 and grid bus 242.

In the exemplary embodiment, a second electrical power transmission path is provided. Electrical, three-phase, sinusoidal, AC power is generated within generator rotor 122 and is transmitted to power conversion assembly 210 via rotor bus 212. Within power conversion assembly 210, the electrical power is transmitted to rotor filter 218 and the electrical power is modified for the rate of change of the PWM signals associated with rotor-side power converter 220. Rotor-side power converter 220 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple associated with AC rectification.

The DC power is subsequently transmitted from DC link 244 to line-side power converter 222 and line-side power converter 222 acts as an inverter configured to convert the DC electrical power from DC link 244 to three-phase, sinusoidal AC electrical power with selectable voltages, currents, and frequencies. This conversion is monitored and controlled via converter controller 262. The converted AC power is transmitted from line-side power converter 222 to system bus 216 via line-side power converter bus 223 and line bus 225, line contactor 226, conversion circuit breaker bus 230, conversion circuit breaker 228, and connection bus 232. Line filter 224 compensates or adjusts for harmonic currents in the electric power transmitted from line-side power converter 222. Stator synchronizing switch 206 is configured to close to facilitate connecting the three-phase power from generator stator 120 with the three-phase power from power conversion assembly 210.

Conversion circuit breaker 228, main transformer circuit breaker 214, and grid circuit breaker 238 are configured to disconnect corresponding buses, for example, when excessive current flow may damage the components of electrical and control system 200. Additional protection components are also provided including line contactor 226, which may be controlled to form a disconnect by opening a switch (not shown in FIG. 2) corresponding to each line of line bus 225.

Power conversion assembly 210 compensates or adjusts the frequency of the three-phase power from generator rotor 122 for changes, for example, in the wind speed at hub 110 and blades 108. Therefore, in this manner, mechanical and electrical rotor frequencies are decoupled from stator frequency.

Under some conditions, the bi-directional characteristics of power conversion assembly 210, and specifically, the bi-directional characteristics of rotor-side power converter 220 and line-side power converter 222, facilitate feeding back at least some of the generated electrical power into generator rotor 122. More specifically, electrical power is transmitted from system bus 216 to connection bus 232 and subsequently through conversion circuit breaker 228 and conversion circuit breaker bus 230 into power conversion assembly 210. Within power conversion assembly 210, the electrical power is transmitted through line contactor 226, line bus 225, and line-side power converter bus 223 into line-side power converter 222. Line-side power converter 222 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple sometimes associated with three-phase AC rectification.

The DC power is subsequently transmitted from DC link 244 to rotor-side power converter 220 and rotor-side power converter 220 acts as an inverter configured to convert the DC electrical power transmitted from DC link 244 to a three-phase, sinusoidal AC electrical power with selectable voltages, currents, and frequencies. This conversion is monitored and controlled via converter controller 262. The converted AC power is transmitted from rotor-side power converter 220 to rotor filter 218 via rotor filter bus 219 and is subsequently transmitted to generator rotor 122 via rotor bus 212, thereby facilitating sub-synchronous operation.

Power conversion assembly 210 is configured to receive control signals from turbine controller 202. The control signals are based on sensed conditions or operating characteristics of wind turbine 100 and electrical and control system 200. The control signals are received by turbine controller 202 and used to control operation of power conversion assembly 210. Feedback from one or more sensors may be used by electrical and control system 200 to control power conversion assembly 210 via converter controller 262 including, for example, conversion circuit breaker bus 230, stator bus and rotor bus voltages or current feedbacks via second set of voltage and electric current sensors 254, third set of voltage and electric current sensors 256, and fourth set of voltage and electric current sensors 264. Using this feedback information, and for example, switching control signals, stator synchronizing switch control signals and system circuit breaker control (trip) signals may be generated in any known manner. For example, for a grid voltage transient with selectable characteristics, converter controller 262 will at least temporarily substantially suspend the IGBTs from conducting within line-side power converter 222. Such suspension of operation of line-side power converter 222 will substantially mitigate electric power being channeled through power conversion assembly 210 to approximately zero.

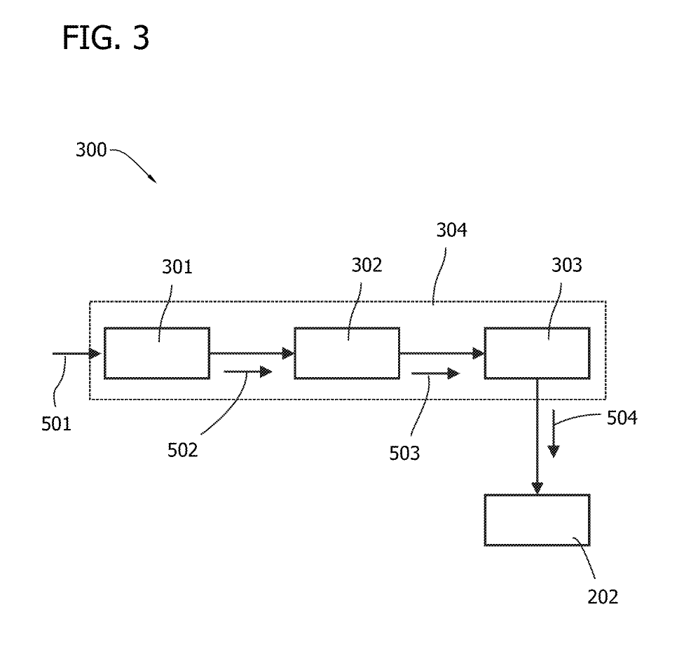

FIG. 3 is a block diagram of a utility grid stabilizing system 300 according to a typical embodiment. The utility grid stabilizing system 300 includes a control signal generation unit 304 and the wind turbine controller 202. The control signal generation unit 304 is adapted for generating a control signal for controlling the wind turbine 100 based on measured upwind velocity. In order to stabilize a grid which is connected to the at least one wind turbine 100 within a wind farm, an upwind velocity 501, i.e. a wind velocity in an upwind direction in front of the respective wind turbine 100, is measured by means of a wind velocity measurement device 301. The wind velocity measurement device 301 provides, as an output signal, wind velocity measurement data, e.g. a wind velocity measurement signal 502 which represents the measured wind velocity 501 in an upwind direction. In order to measure the wind velocity in an upwind direction, the wind velocity measurement device 301 may include, but is not restricted to, a LIDAR system, a Doppler RADAR system, a SODAR system, and an ultrasonic anemometer, and any combinations thereof.

As used herein, the term “LIDAR” is intended to be representative of a procedure and/or a system adapted for measuring properties of ambient air, e.g. an upwind velocity, by means of light detection and ranging (LIDAR: light detection and ranging). Furthermore, as used herein, the term “RADAR” is intended to be representative of a procedure and/or a system adapted for measuring upwind velocity by means of radio frequency detection and ranging (RADAR: radio detection and ranging). In addition to that, as used herein, the term “SODAR” is intended to be representative of a procedure and/or a system adapted for measuring upwind velocity using sonic detection and ranging (SODAR: sound/sonic detecting and ranging).

Thereby, an upwind velocity 501 at a selectable distance in front of the wind turbine 100 in an upwind direction in front of the wind turbine may be measured using the wind velocity measurement device 301. According to the measurement signal 502 obtained from the wind velocity measurement device 301, near-future power estimation such as energy excess evaluation may be performed. Excess power may be used, e.g. for a stabilization procedure of a connected utility grid (not shown in FIG. 3). Thereby, grid destabilization events may be compensated, at least partially. By estimating the wind velocity at the location of the wind turbine 100, grid stability may be increased.

According to a typical embodiment, which may be combined with other embodiments described herein, the wind velocity measurement device 301 is a LIDAR which provides wind velocity (wind speed) measurement upfront the wind turbine. According to a typical modification thereof, wind velocity may be measured at an upwind distance in a range from 2 meters to 1000 meters, typically in a range from 10 meters to 800 meters, and more typically in a range from 20 meters to 500 meters in front of the wind turbine, i.e. in an upwind direction. Thereby, a estimation distance (temporally and spatially) can be adjusted and used according to a specific application. According to yet another modification thereof measuring the wind velocity may include measuring wind velocity within a solid angle in a range from 0.03 steradiant to 0.8 steradiant in an upwind direction in front of the wind turbine, and more typically in a range from 0.05 steradiant to 0.5 steradiant in an upwind direction in front of the wind turbine. As used herein, the term “steradiant” is intended to be representative of a unit of an aperture angle of a cone (i.e. a cone angle), the cone defining possible upwind directions. Thereby, the tip of the upwind cone may be located approximately at the hub of the wind turbine 100 and the central axis of the upwind cone may be represented approximately as the extension of the rotor axis of the wind turbine. The cone angle may thus be indicated in “steradiant” corresponding to the measure of “radiant” used to e.g. define an angle between two straight lines.

A filtering unit 302 may be operatively connected to the wind velocity measurement device 301. The filtering unit (filtering module) 302 receives the wind velocity measurement data (wind velocity measurement signal) 502 output from the wind velocity measurement device 301. A filtering procedure which may be performed at the filtering module 302 includes, but is not restricted to, filtering the wind velocity measurement signal 502 spatially and/or temporally. After the spatial and/or temporal filtering, a correct estimation of the upcoming wind speed, i.e. a filtered wind velocity measurement signal 503 may be obtained. Then, the obtained filtered measurement signal 503 is fed to a determination unit 303 adapted for determining a control signal for controlling the wind turbine 100 based on the filtered wind velocity measurement signal 503. The filtered wind velocity signal 503 may be provided as a wind velocity estimation signal such that a wind velocity in an upwind direction may be estimated. Thereby, power excess evaluation may be performed with respect to power excess provided by the wind turbine, based on the estimated wind velocity. Operating the wind turbine in response to the estimated wind velocity facilitates power management in a connected utility grid. For example, excess power may be used for stabilizing the utility grid in case a sudden load is applied at the utility grid. Furthermore, power stabilization in the utility grid may be provided in case other energy sources connected to the utility grid provide reduced power input. According to a modification thereof, an estimator unit may be provided adapted for estimating the wind velocity at the location of the wind turbine based on the upwind velocity measurement signal provided as an input to the control signal generation unit 304.

A specific wind turbine 100 may be operated in response to the estimated wind velocity by using the control signal 504 output from the determination unit 303. The control signal 504 is received by the wind turbine controller (main controller of the wind turbine) 202 which is operatively connected to the control signal generation unit 304 and the determination unit 303, respectively. Thereby, the control signal generation unit 304 provides an estimate of the near-future power (near-future energy) which can be safely provided by the wind turbine 100 for the utility grid (power grid). The wind velocity measurement device 301, which may be provided as a LIDAR, thus provides a feed-forward signal for such an estimate. The wind velocity measurement device 301 may be turbine-mounted or may be a fixed or rotating system. The amount of excess energy can thus be safely provided to the utility grid in order to improve transient stability, sustain frequency within acceptable limits and mitigate voltage peaks and dips (rises and collapses).

Thereby, operating the wind turbine 100 in response to the estimated wind velocity includes at least one of the group consisting of controlling power generation of the wind turbine 100, providing stable frequency operation, providing efficient power dispatching, smoothing grid disturbances, compensating, at least partially, grid destabilization events within a utility grid connected to the wind turbine, or any combinations thereof.

According to a typical embodiment, which may be combined with other embodiments described herein, the wind velocity measurement device 301 provides raw data of the wind velocity as measured at a certain distance, the distance being constant or variable. Due to the propagation delays and spatial distortion, the raw data may not be appropriate for further processing. Thus, the raw data may be filtered, e.g. low-pass filtered and compensated with respect to delay, through a propagation model filtering. Furthermore, packet losses may be compensated.

In addition to that, in particular for nacelle-mounted wind velocity measurement devices 301, blade passage at 3P of the rotor 106 of the wind turbine 100 may introduce periodic losses in the data (at constant speed operation) and non-periodic losses (at variable speed operation). These losses may be compensated by reconstructing missing data through the use of redundant information provided by the measurements, if more than one gateway point measurement is available, or through the combination of the use of wind velocity estimators (wind speed estimators, software sensors or estimators).

According to a typical embodiment, which may be combined with other embodiments described herein, a typical estimation distance, i.e. an upwind distance in front of the wind turbine where the upfront wind velocity is measured, may be in a range from 20 m to 500 m. This may be an appropriate upwind measurement distance for average wind velocities of 7 m/s to 8 m/s prevailing in Central Europe. This anticipated wind velocity (wind speed) may be provided by a single wind velocity measurement device 301 arranged at the wind turbine 100, or by a number of wind velocity measurement devices 301, e.g. by a number of wind speed sensors arranged at different wind turbines 100. According to yet another modification thereof, the wind velocity is measured in an upwind direction at a point in time in a range from 1 second to 90 seconds, and more typically in a range from 2 seconds to 70 seconds before the measured wind velocity appears at the rotor of the wind turbine. Thus, a wind velocity may be measured in a selectable time range before this wind velocity is present at the rotor of the wind turbine. Thereby, a selectable time range may be provided for control operations, e.g. for controlling power output of the wind turbine in response to an estimated wind velocity and measured grid parameters. The time range may be estimated based on the average wind velocity and the selected upwind distance of the wind turbine where the wind velocity is detected. thus, based on an average wind velocity, a selectable reaction time for the utility grid, i.e. a time for control operations such that the grid is at least partially stabilized, may be provided.

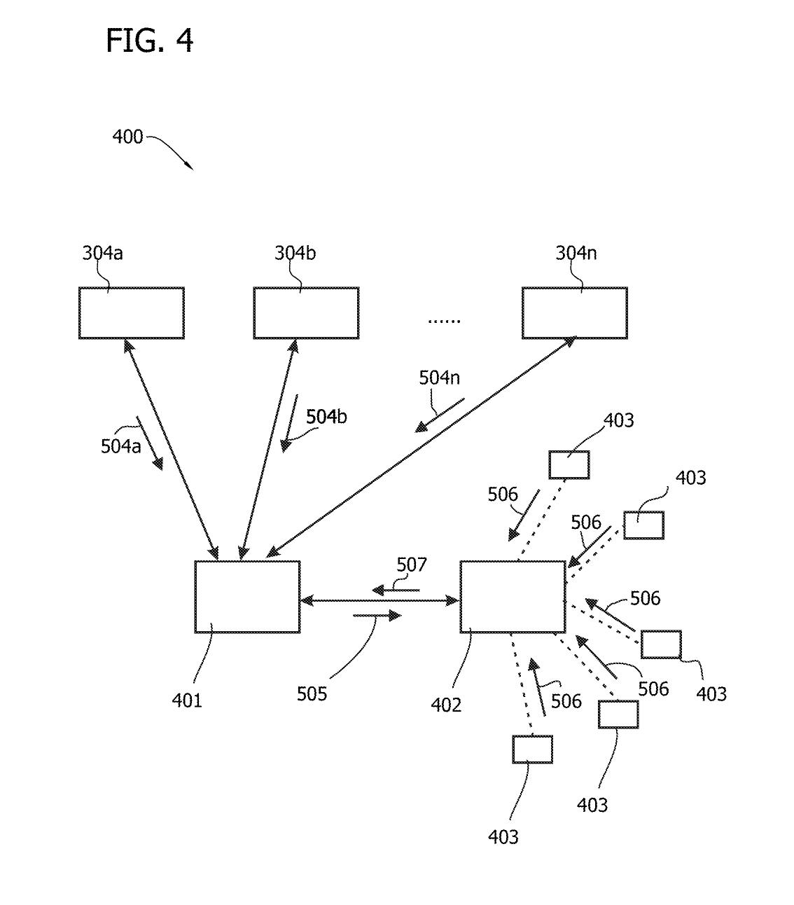

FIG. 4 is a block diagram illustrating a wind farm control system 400 adapted for controlling a utility grid based on estimated upwind velocities. In FIG. 4 a number of control signal generation units 304a, 304b, . . . , 304n are shown. These control signal generation units each correspond to a respective wind turbine 100 including the wind turbine controller 202 (main controller, see FIG. 3) and provide a respective control signal 504a, 504b, . . . , 504n. The control data 504 (control signals) contain information on excess energies ΔP₁ and times Δt₁ at which the excess energy may be available. Each control signal thus provides information on available excess energy at a specific time according to the following relations (1):

control signal 504a≡(ΔP₁,Δt₁),

control signal 504b≡(ΔP₂,Δt₂), . . . ,

control signal 504n≡(ΔPₙ,Δtₙ) (1)

The control signals 504a, 504b, . . . , 504n are received by a wind farm operator 401. The wind farm operator 401 may be provided as a main operation device to which all wind turbines 100 of the wind farm are connected. In response to receiving the respective control signals 504a, 504b, . . . , 504n, the wind farm operator 401 may provide a cumulative power excess signal 505, which may be represented by the following equation (2):

$$Δ {P}^{c} = {\sum }_{i ∈ \{ x ; Δ {t}_{j} = Δ {t}_{k} , j , k ∈ x \}} Δ {P}_{i} \qquad ( 2 )$$

In equation (2) shown herein above, j and k are indices which belong to the set of indices of all the wind turbines 100. Thereby, a sum of wind farm excess power may be estimated a certain time ahead. Furthermore it is noted here that Δtⱼ may only be approximately equal to Δtₖ, i.e. Δtⱼ and Δtₖ may not be strictly equal. The cumulative power excess signal 505 represents information on cumulative power ΔP^{c} and times Δt^{c} at which the power excess may be provided, i.e. cumulative power excess signal 505≡(ΔP^{c},Δt^{c}). The cumulative power excess signal 505 is then fed to a grid operator 402 which is operatively connected to the wind farm main operator 401. The grid operator 402 is adapted for determining actual grid parameters of the utility grid. Actual grid parameters are obtained as grid parameter signals 506 from individual grid parameter measurement units 403. As an example, the arrangement of FIG. 4 exhibits five different grid parameter measurement units 403 which provide respective grid parameter signals 506 for the grid operator 402. The grid operator 402 may provide a grid condition signal 507 for the wind farm operator 401. Thus, the wind farm operator 401 may obtain information about the utility grid and its state, respectively, from the grid operator 402, whereas the grid operator 402 may receive the cumulative power excess signal 505, i.e. information about cumulative power excess and time of availability from the wind farm operator 401.

Thereby, by providing estimations of upwind conditions and conditions of a utility grid connected to the wind farm, a wind farm control system may be provided by the interaction of the wind farm operator 401 and the grid operator 402. The grid parameter measurement units 403 shown in FIG. 4 and being operatively connected to the grid operator 402 may be provided as phasor measurement units. According to a further alternative, the grid parameters which may be measured by the grid parameter measurement units 403 may be selected from the group consisting of a grid voltage, a grid current, a grid power, a grid phase angle, and any combinations thereof.

Thus, using the coordination between the wind farm and a connected utility grid, the stability of the utility grid may be increased by controlling at least one wind turbine with respect to its power generation. Thereby, a more stable frequency operation, an efficient power dispatching and short-term energy pricing may be provided by using the described procedure. The utility grid and/or the wind farm operator is provided with information about which turbine has excess power (a power reserve) or delivers reduced power resulting from increasing or decreasing wind speeds in the near future (e.g. in the next few seconds). Using this information, a request for stabilizing the utility grid can be distributed among these wind turbines 100. Using this procedure, less power reserve for an individual wind turbine 100 may be provided, and thus energy loss caused by “grid stabilization reserve” may be reduced. Thus, a control strategy according to embodiments described herein includes providing knowledge about wind resources and thus providing better usage of energy excess by controlling power generation of at least one wind turbine based on estimated wind velocity and measured grid parameters.

According to further embodiment which may be combined with other embodiments described herein, the wind velocity may be measured at at least one wind turbine and the generated signal, e.g. the wind velocity measurement signal which is obtained from said wind velocity may then be communicated to at least a second wind turbine for controlling power generation of said second wind turbine. According to another modification thereof, controlling power generation of the wind farm may include dynamically grouping of at least two wind turbines such that the grouped wind turbines are controlled based on a common wind velocity measurement signal. In a wind farm, some of the wind turbines may be provided with a wind velocity measurement device according to embodiments described herein, whereas other wind turbines may not be provided with such a wind velocity measurement device. In this case information of upwind velocity may be provided for those wind turbines without wind velocity measurement device from wind turbines with wind velocity measurement devices. In a wind farm such information transfer may be used for efficient grid stabilization.

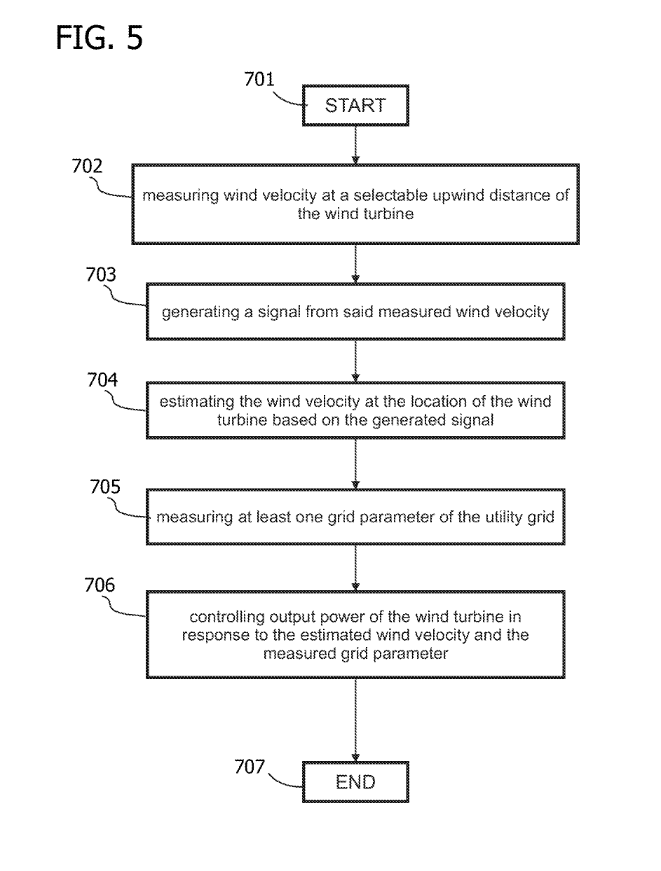

FIG. 5 is a flowchart illustrating a method for controlling power generation of at least one wind turbine 100 according to a typical embodiment which may be combined with other embodiments described herein. At a block 701, the procedure is started. Wind velocity at a selectable upwind distance in front of the wind turbine 100, i.e. an upwind speed, is measured in an upwind direction of the wind turbine by means of the wind velocity measurement device 301 (block 702). Then, a signal, e.g. a wind velocity measurement signal 503 is generated from said measured wind velocity, in a block 703.

According to a typical modification thereof, wind velocity may be estimated at an upwind distance in a range from 2 meters to 1000 meters, typically in a range from 10 meters to 800 meters, and more typically in a range from 20 meters to 500 meters in front of the wind turbine, i.e. in an upwind direction, based on the generated signal (block 704). Then, at a block 705, at least one grid parameter of the utility grid is measured. In a block 706, power output of the wind turbine in response to the estimated wind velocity and the measured grid parameter is controlled. The procedure may further include evaluating power excess provided by the wind turbine based on the estimated wind velocity. The procedure is ended at a block 707. It is noted here that procedure according to FIG. 5 may be represented as a computational scheme and may be executed repeatedly according to a selectable sampling period.

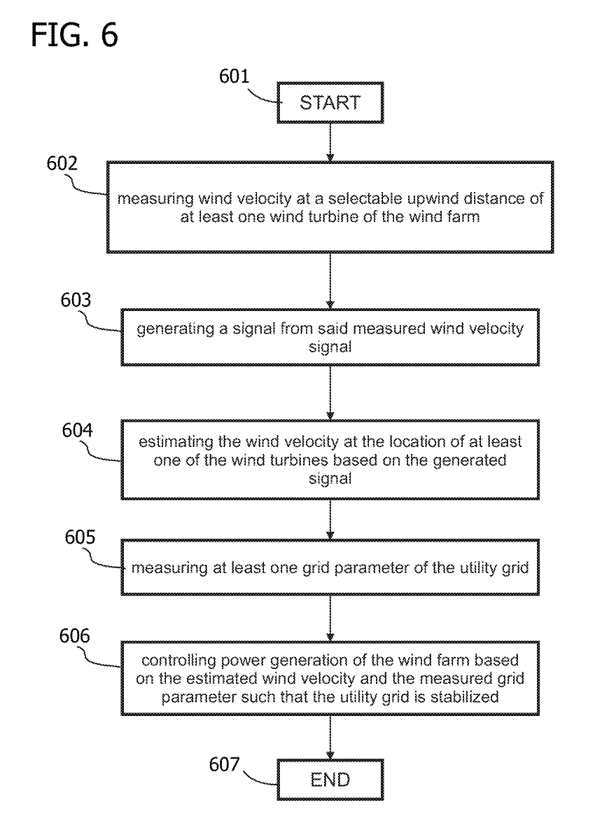

FIG. 6 is a flow chart illustrating a method for operating a wind farm including at least two wind turbines 100. At a block 601, the procedure is started. Wind velocity at a selectable upwind distance in front of at least one wind turbine of the wind farm is measured in an upwind direction of the wind turbine, using a wind velocity measurement device 301 arranged at at least one wind turbine (block 602). The wind velocity measurement device 301 arranged at the wind turbine 100 generates at least one signal, e.g. a wind velocity measurement signal 502, in a block 603, which may be spatially and temporally filtered.

According to a typical embodiment which may be combined with other embodiments described herein, a distributed wind velocity sensor network may be provided such that not only one wind turbine includes an upwind velocity measurement device 301, but a number of wind turbines 100 include this device. An arrangement with distributed upwind velocity measurement devices 301 arranged at different wind turbines 100 provides more accurate estimation of wind velocity at the location of the wind turbine which converts the wind energy into electrical power. In particular, this procedure may be used in power supply systems, where a large percentage of the power is provided by the conversion of wind energy, using wind turbines 100. Thereby, a stability increase based on the control of different wind turbines 100 connected within a wind farm may be provided. Wind resource utilization may thus be improved and the stabilization of a connected utility grid may be facilitated.

The wind velocity is estimated at the location of the wind turbine 100 based on the generated signal (block 604), at least one grid parameter of the utility grid is measured (block 605), and the power generation of the wind farm including the at least two wind turbines is controlled based on the estimated wind velocity and the measured grid parameter (block 606). As grid parameters of a utility grid connected to the wind farm are measured, power generation of the entire wind farm may be based on both estimated wind speed and measured grid parameters. The measured grid parameters may be selected from the group consisting of a grid voltage, a grid current, a grid power, a grid phase angle, and any combinations thereof. Thus, the utility grid may be stabilized. The procedure is ended at a block 607.

The procedure according to FIG. 6 may be applied to any source of energy having fast ramp-up (or ramp-down) capabilities. Any power excess may be measured with respect to the current power production of the wind farm. The power excess can be positive or negative. By a proper placement and a set of algorithms, data of the wind velocity measurement devices 301 (e.g. LIDAR data) may be shared between different wind turbines 100. Thereby, embodiments described herein may also be applied to other systems having one or more energy sources with varying power production. It is noted here that procedure according to FIG. 6 may be represented as a computational scheme and may be executed repeatedly according to a selectable sampling period.

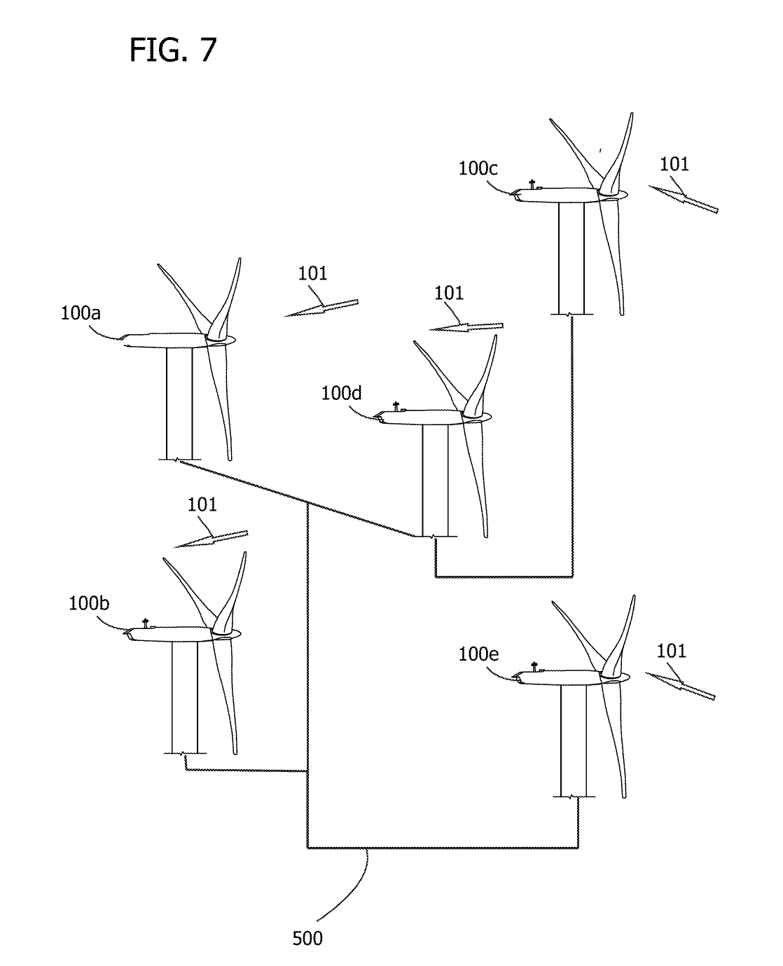

FIG. 7 is a block diagram illustrating a wind farm including a number of wind turbines, e.g. the wind turbines 100a, 100b, 100c, 100d, 100e connected to a utility grid 500. In a wind farm the wind directions 101 may change, both with respect to the wind farm in its entirety and with respect to individual wind turbines arranged in the wind farm. In the example shown in FIG. 7, wind turbines 100a and 100b are exposed to approximately same wind direction 101, whereas wind turbines 100c and 100e are exposed to a different wind direction 101. It may thus be appropriate to control wind turbines 100a, 100b based on a wind velocity measurement signal which is obtained at only one of the wind turbines 100a or 100b. On the other hand, it may appropriate to control wind turbines 100c, 100e based on a wind velocity measurement signal which is obtained at only one of the wind turbines 100c or 100e. Power generation at wind turbine 100d, e.g. may be based on a wind velocity measurement signal obtained at wind turbine 100d. Furthermore, power generation at wind turbine 100d may be based on an averaged wind velocity measurement signal obtained at wind turbines 100a and 100c or 100b and 100e, respectively.

According to a further embodiment which can be combined with other embodiments described herein, controlling power generation of the wind farm may include grouping of at least two wind turbines, e.g. grouping the wind turbines 100a and 100b, or the wind turbines 100c and 100e, respectively, such that the grouped wind turbines are controlled based on a commonly measured wind velocity. In a wind farm, some of the wind turbines may be provided with a wind velocity measurement device 301 according to embodiments described herein, whereas other wind turbines may not be provided with such a wind velocity measurement device. In this case information of upwind velocity and its direction 101 may be provided for those wind turbines without wind velocity measurement device from wind turbines with wind velocity measurement devices 301. Thereby stabilization of the utility grid 500 may be provided by information transfer between individual wind turbines. It is noted here that grouping of at least two wind turbines such that a common wind velocity measurement signal may be provided is not limited to a stationary configuration, rather controlling power generation of the wind farm may also include a dynamic grouping of at least two wind turbines such that the grouped wind turbines are controlled based the common wind velocity measurement signal. According to another embodiment which may be combined with embodiments described herein, controlling power output in response to the estimated wind velocity and the measured grid parameter may include controlling blade pitch and/or torque demand of at least one rotor blade of at least one wind turbine.

Exemplary embodiments of methods and systems for improving grid stability in a wind farm are described above in detail. The methods and systems are not limited to the specific embodiments described herein, but rather, components of the devices and/or steps of the methods may be utilized independently and separately from other components and/or steps described herein. For example, grid control procedures described herein above may be applied in electrical grids wherein electrical energy is provided by other energy sources than wind energy conversion.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for controlling power generation of at least one wind turbine connected to a utility grid, the method comprising:
measuring wind velocity at a selectable upwind distance of the wind turbine;
generating a signal from said measured wind velocity;
estimating the wind velocity at the location of the wind turbine based on the generated signal;
measuring at least one grid parameter of the utility grid; and,
controlling power output of the wind turbine in response to the estimated wind velocity and the measured grid parameter.

2. The method according to claim 1, wherein measuring the wind velocity comprises measuring wind velocity within a solid angle in a range from 0.03 steradiant to 0.8 steradiant in an upwind direction in front of the wind turbine.

3. The method according to claim 1, wherein measuring the wind velocity at a selectable distance of the wind turbine comprises measuring the wind velocity by means of a sensing system selected from the group consisting of a LIDAR system, a Doppler RADAR system, a SODAR system, an ultrasonic anemometer, and any combinations thereof.

4. The method according to claim 1, wherein the wind velocity is measured at an upwind distance in a range from 20 m to 500 m in front of the wind turbine.

5. The method according to claim 1, wherein the wind velocity is measured in an upwind direction at a point in time in a range from 1 second to 90 seconds before the measured wind velocity appears at the rotor of the wind turbine.

6. The method according to claim 1, further comprising evaluating power excess provided by the wind turbine based on the estimated wind velocity.

7. The method according to claim 1, wherein controlling power output in response to the estimated wind velocity and the measured grid parameter comprises controlling blade pitch and/or torque demand of at least one rotor blade of the wind turbine.

8. The method according to claim 1, wherein controlling power output in response to the estimated wind velocity and the measured grid parameter comprises at least one of the group consisting of controlling power generation at a generator of the wind turbine, providing stable frequency operation, providing efficient power dispatching, smoothing grid disturbances, partially compensating grid destabilizing events, completely compensating grid destabilizing events and any combinations thereof.

9. The method according to claim 1, wherein the measured grid parameter is selected from the group consisting of a grid voltage, a grid current, a grid power, a grid phase angle, and any combinations thereof.

10. A method for operating a wind farm including at least two wind turbines connected to a utility grid, the method comprising:
measuring wind velocity at a selectable upwind distance of at least one wind turbine of the wind farm;
generating a signal from said measured wind velocity;
estimating the wind velocity at the location of at least one of the wind turbines based on the generated signal;
measuring at least one grid parameter of the utility grid; and,
controlling power generation of the wind farm based on the estimated wind velocity and the measured grid parameter such that the utility grid is stabilized.

11. The method according to claim 10, wherein measuring the wind velocity comprises measuring wind velocity within a solid angle in a range from 0.03 steradiant to 0.8 steradiant in an upwind direction in front of the wind turbine.

12. The method according to claim 10, wherein the wind velocity is measured at at least one wind turbine, and wherein the generated signal from said wind velocity is communicated to at least a second wind turbine for controlling power generation of said second wind turbine.

13. The method according to claim 10, wherein controlling power generation of the wind farm further comprises dynamically grouping of at least two wind turbines such that the grouped wind turbines are controlled based on a common wind velocity measurement signal.

14. A utility grid stabilizing system adapted for controlling stability of a grid connected to a wind turbine, the grid stabilizing system comprising:
a wind turbine controller adapted for controlling the wind turbine;
a wind velocity measurement device operatively connected to the wind turbine controller and being adapted for measuring wind velocity at a selectable upwind distance of the wind turbine; and,
a grid operator operatively connected to the wind turbine controller and being adapted for determining actual grid parameters of the utility grid, wherein
the controller is configured to control operation of the wind turbine based on the measured wind velocity and the actual grid parameters.

15. The grid stabilizing system according to claim 14, further comprising a control signal generation unit adapted for generating a control signal for controlling the wind turbine based on measured upwind velocity.

16. The grid stabilizing system according to claim 14, further comprising a wind farm operator operatively connected to the grid operator and being adapted for controlling at least two wind turbines arranged in a wind farm, wherein the at least two wind turbines are controlled based on the measured wind velocity and the actual grid parameters.

17. The grid stabilizing system according to claim 14, further comprising an estimator unit adapted for estimating the wind velocity at the location of the wind turbine based on measured upwind velocity.

18. The grid stabilizing system according to claim 14, wherein the wind velocity measurement device comprises a sensing system selected from the group consisting of a LIDAR system, a Doppler RADAR system, a SODAR system, an ultrasonic anemometer, and any combinations thereof.

19. The grid stabilizing system according to claim 14, further comprising a filtering unit adapted for spatially and/or temporally filtering a wind velocity measurement signal output from the wind velocity measurement device.

20. The grid stabilizing system according to claim 14, further comprising a determination unit adapted for determining a control signal for controlling the wind turbine based on the filtered wind velocity measurement signal.
